(19) United States
(12) Patent Application Publication
(10) Pub. No.: US 2025/0033338 A1
(43) Pub. Date: Jan. 30, 2025

(54) PLANARIZED INORGANIC THIN FILM TRANSFER ARTICLE

(71) Applicant: 3M INNOVATIVE PROPERTIES COMPANY, St. Paul, MN (US)

(72) Inventors: Kevin W. Gotrik, Hudson, WI (US); Scott J. Jones, Woodbury, MN (US); Christopher S. Lyons, St. Paul, MN (US); Cedric Bedoya, Woodbury, MN (US)

(21) Appl. No.: 18/704,977

(22) PCT Filed: Nov. 22, 2022
(86) PCT No.: PCT/IB2022/061266

§ 371 Date: Apr. 26, 2024

Related U.S. Application Data
(60) Provisional application No. 63/265,650, filed on Dec. 17, 2021.

(51) Int. Cl. B32B 37/00; B32B 7/06; B32B 15/082; B32B 27/08; B32B 27/30; B32B 27/36

(52) U.S. Cl. CPC B32B 37/025; B32B 7/06; B32B 15/082; B32B 27/08; B32B 27/308; B32B 27/36; B32B 2307/7376; B32B 2307/748

(57) ABSTRACT

A transfer article (100) comprising a substrate (110), a first acrylate layer (120) overlaying the substrate layer (110), a release layer (130) overlaying the first acrylate layer (120), a second acrylate layer (140) overlaying the release layer (130), and a function layer (150) overlaying the second acrylate layer (140). The release layer (130) comprises a metal layer or a doped semiconductor layer. The function layer (150) may be applied to a surface of a receiving article (170) and the release layer (130) removed from the receiving article (170) such that the function layer (150) and second acrylate layer (140) remain on the surface of the receiving article (170).

### BACKGROUND

Transfer articles generally include a release layer and a function layer separable from the release layer. The function layer can be made up of one or more individual layers and is typically applied to the surface of an article to impart additional and/or enhanced properties to that article. The release layer can then be discarded or re-used, depending upon the process. For example, many electronic devices are sensitive to environmental factors and prone to degradation upon exposure to environmental gases and liquids. Transfer articles can be used to apply a function layer comprising inorganic or hybrid inorganic/organic barrier layers to the surface of electronic devices to protect sensitive electronic components from exposure to oxygen and water vapor. The release layer can then be removed from the function layer and discarded. Alternatively, the release layer can be removed from the function layer and reused.

Transfer articles are disclosed, for example, in U.S. Pat. No. 11,117,358 (Gotrik, et al.) and comprise a release layer, a first acrylate layer overlaying the release layer, and a function layer overlaying the first acrylate layer, wherein a release value between the release layer and the first acrylate layer is from 2 to 50 g/inch. The release layer comprises a metal layer or a doped semiconductor layer and is typically prepared by evaporation, reactive evaporation, sputtering, reactive sputtering, chemical vapor deposition, plasma enhanced chemical vapor deposition, and atomic layer deposition onto a substrate.

### SUMMARY

In the case of the transfer article disclosed in U.S. Pat. No. 11,117,358 (Gotrik, et al.), it has been found that the thickness of the deposited release layer is preferably greater than the size of any surface irregularities on the substrate, such as irregularities due to surface debris or manufacturing defects. If the thickness of the release layer is not sufficient to create a smooth surface onto which the acrylate layer is applied, both the functionality and stability of the transfer article can be affected.

Reducing the thickness of the release layer can provide multiple benefits. For example, thinner release layers can translate to lower material cost and/or lower processing times related to the deposition of the release material. Additionally, in some instances, one or more resin layers of a transfer article may comprise an ultraviolet (UV) curable resin, and it may be preferable from a processing standpoint to cure the resin through the substrate and release layer. Thinner release layers are more transmissible to UV radiation. Therefore, there is a need for thinner release layers without compromising on the functionality or the stability of the transfer article.

It has been found that when the substrate is planarized by an acrylate layer prior to application of the release layer, it is possible to reduce the amount of metal or doped semiconductor needed to form the release layer. This can lead to less costly transfer articles, reduced processing time for metal or doped semiconductor deposition, comparable or greater overall transfer article stability, and/or greater UV transmissibility through the release layer.

The present disclosure provides a planarized inorganic thin film transfer article.

In one embodiment, the present disclosure provides a transfer article comprising: a substrate; a first acrylate layer overlaying the substrate layer, the first acrylate layer having a thickness of at least 200 nm; a release layer overlaying the first acrylate layer, the release layer comprising a metal layer or a doped semiconductor layer and having a thickness up to 50 nm; a second acrylate layer overlaying the release layer, and a function layer overlaying the second acrylate layer.

In another embodiment, the present disclosure provides a method comprising: applying the transfer article to a surface of a receiving article, the function layer being between the release layer and the surface of the receiving article; and removing the release layer from the second acrylate layer, wherein the second acrylate layer and the function layer are left on the surface of the receiving article after removal of the release layer.

The above summary of the present disclosure is not intended to describe each disclosed embodiment or every implementation of the present disclosure. The description that follows more particularly exemplifies illustrative embodiments.

### BRIEF DESCRIPTION OF THE DRAWINGS

FIG. 1 is a schematic side view of one embodiment of a transfer article having a function layer and release layer according to the present disclosure; and

FIG. 2 is a schematic side view demonstrating transfer of the function layer from the transfer article of FIG. 1 to a receiving article.

Unless otherwise indicated, all figures and drawings in this document are not to scale and are chosen for the purpose of illustrating different embodiments of the invention. In particular, the dimensions of the various components are depicted in illustrative terms only, and no relationship between the dimensions of the various components should be inferred from the drawings, unless so indicated.

### DETAILED DESCRIPTION

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The terms “a,” “an,” and “the” are used interchangeably with “at least one” to mean one or more of the components being described.

The term “and/or” means one or all of the listed elements or a combination of any two or more of the listed elements.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The term “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The terms “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

All numbers are assumed to be modified by the term “about”. As used herein in connection with a measured quantity, the term “about” refers to that variation in the measured quantity as would be expected by the skilled artisan making the measurement and exercising a level of care commensurate with the objective of the measurement and the precision of the measuring equipment used.

The recitations of numerical ranges by endpoints include all numbers subsumed within that range as well as the endpoints (e.g., 1 to 5 includes 1, 1.5, 2, 2.75, 3, 3.80, 4, 5, etc.). The phrase “up to” a number (e.g., up to 50) includes the number (e.g., 50).

The term “release value” with reference to average peel force is determined by the test for T-Peel Test Method or 180° Peel Test Method in Examples.

The term “overlay” means to extend over so as to at least partially cover another layer or element. Overlaying layers can be in direct or indirect contact (e.g., separated by one or more additional layers).

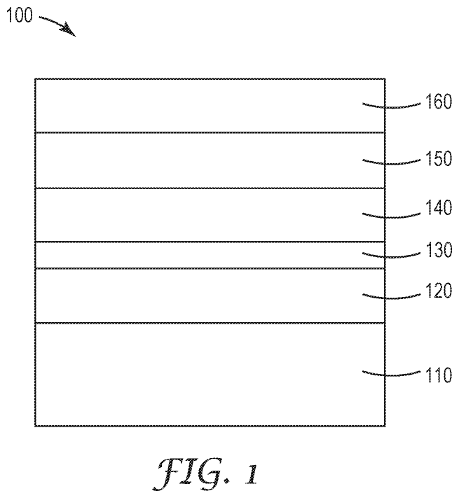

The present disclosure provides transfer articles and methods of using these transfer articles. An exemplary transfer article is illustrated in FIG. 1. The transfer article 100 includes a substrate 110, a first acrylate layer 120 overlaying the substrate layer 110, a release layer 130 overlaying the first acrylate layer 120, a second acrylate layer 140 overlaying the release layer 130, and a function layer 150 overlaying the second acrylate layer 140. The release layer 130 includes a metal layer or a doped semiconductor layer.

In FIG. 1, the first acrylate layer 120 is in direct contact with the substrate 110 and the release layer 130. In other embodiments, there can be additional layers between the release layer 130 and the first acrylate layer 120. Similarly, in FIG. 1 the second acrylate layer 140 is in direct contact with the release layer 130 and the function layer 150. In other embodiments, there can be additional layers between the second acrylate layer 140 and the function layer 150. The transfer article 100 may optionally include an adhesive layer 160 for attachment to a receiving article.

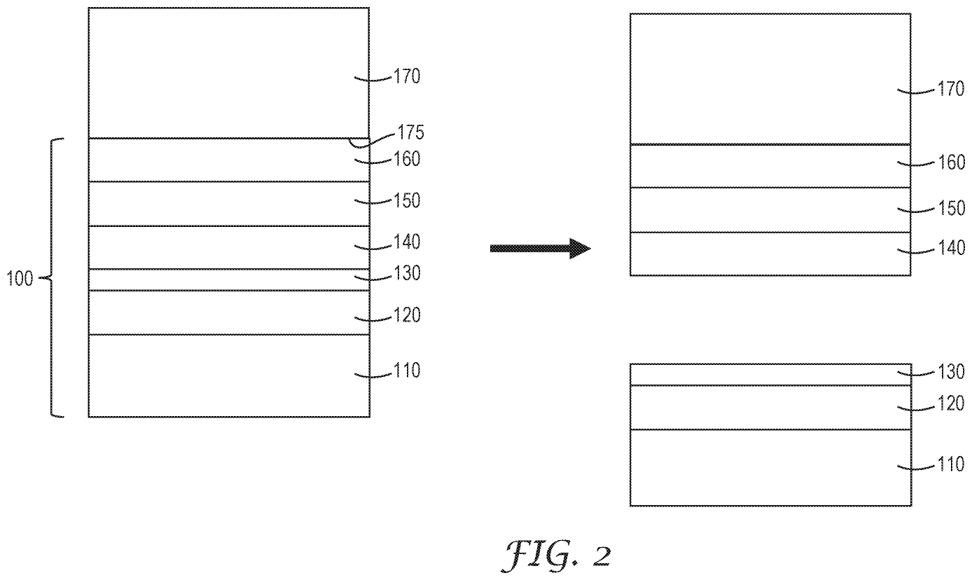

As illustrated in FIG. 2, the transfer article 100 is used to transfer the second acrylate layer 140 and the function layer 150 to a surface 175 of a receiving article 170. The transfer article 100 is applied to the surface of the receiving article 170 such that the function layer 150 is between the release layer 130 and the surface 175 of the receiving article 170. The transfer article 100 can be attached to the receiving article 170 using the optional adhesive layer 160, as illustrated in FIG. 2. Alternatively, attachment can occur through an adhesive layer on the surface of the receiving article. Other forms of attachment may be used, including heat lamination. Once the transfer article 10) is attached, the release layer 130 is removed or separated from the second acrylate layer 140. The second acrylate layer 140 and function layer 150 remain attached to the receiving article 170. The substrate 110, first acrylate layer 120, and release layer 130 (i.e. remainder) can be discarded or, more preferably, reused to make additional transfer articles. In some embodiments, a portion or all of the second acrylate layer 140 may be subsequently etched away to reveal some or all of the function layer 150.

In some embodiments, a release value between the release layer 130 and the second acrylate layer 140 is less than 60 g/inch, 50 g/inch, 40 g/inch, 30 g/inch, 20 g/inch, 15 g/inch, 10 g/inch, 9 g/inch, 8 g/inch, 7 g/inch, 6 g/inch, 5 g/inch, 4 g/inch, or less than 3 g/inch. In some embodiments, a release value between the release layer 130 and the second acrylate layer 140 is more than 1 g/inch, 2 g/inch, 3 g/inch, or more than 4 g/inch. In some embodiments, a release value between the release layer 110 and the second acrylate layer 120 is from 1 to 60 g/inch, from 1 to 50 g/inch, from 1 to 40 g/inch, from 1 to 30 g/inch, from 1 to 20 g/inch, from 1 to 15 g/inch, from 1 to 12 g/inch, from 1 to 10 g/inch, from 1 to 8 g/inch, from 2 to 60 g/inch, from 2 to 50 g/inch, from 2 to 40 g/inch, from 2 to 30 g/inch, from 2 to 20 g/inch, from 2 to 15 g/inch, from 2 to 12 g/inch, from 2 to 10 g/inch, or from 2 to 8 g/inch.

### Substrates

The substrate 110 is typically an organic polymeric material that exhibits sufficient heat stability and/or optical clarity necessary to withstand the manufacturing process used to make the transfer article. In some preferred embodiments, the substrate is made of an organic polymeric material that transmits UV radiation in the range of 250 nm to 400 nm.

Suitable organic polymeric material may be semi-crystalline or amorphous. In some embodiments, the polymeric material is heat shrinkable. Exemplary semicrystalline polymeric films include polyolefins such as polyethylene (PE), polypropylene (PP), and syndiotactic polystyrene (sPS); polyesters such as polyethylene terephthalate (PET), polyethylene naphthalate (PEN), and polyethylene-2,6-naphthalate; fluoropolymers such as polyvinylidene difluoride, and ethylene:tetrafluoroethylene copolymers (ETFE); polyamides such as Nylon 6 and Nylon 66; polyphenylene oxide, and polyphenylene sulfide. Exemplary amorphous polymer films include polymethylmethacrylate (PMMA), polyimides (PI), polycarbonate (PC), polyether sulfone (PES), atactic polystyrene (aPS), polyvinyl chloride (PVC), and norbornene based cyclic olefin polymer (COP) and cyclic olefin copolymer (COC).

In some embodiments, the substrate comprises polyethylene terephthalate (PET), polycarbonate (PC), polypropylene (PP), or cyclic olefin copolymer (COC). In a preferred embodiment, the substrate comprises PET.

The thickness of the substrate will depend upon application and manufacturing method. In some embodiments, the thickness of the substrate is 1 mil (25.4 μm) to 5 mil (127 μm).

### First Acrylate Layer

The first acrylate layer 120 typically comprises an acrylate or an acrylamide. When the acrylate layers are to be formed by flash evaporation of the monomer, vapor deposition, followed by crosslinking, volatilizable acrylate and methacrylate (referred to herein as “(meth)acrylate”) or acrylamide or methacrylamide (referred to herein as “(meth)acrylamide”) monomers are useful, with volatilizable acrylate monomers being preferred. A suitable (meth)acrylate or (meth) acrylamide monomer has sufficient vapor pressure to be evaporated in an evaporator and condensed into a liquid or solid coating in a vapor coater.

Examples of suitable monomers include, but are not limited to: hexanediol diacrylate; ethoxyethyl acrylate; cyanoethyl (mono)acrylate; isobornyl (meth)acrylate; octadecyl acrylate; isodecyl acrylate; lauryl acrylate; beta-carboxyethyl acrylate; tetrahydrofurfuryl acrylate; dinitrile acrylate; pentafluorophenyl acrylate; nitrophenyl acrylate; 2-phenoxyethyl (meth)acrylate; 2,2,2-trifluoromethyl (meth)acrylate; diethylene glycol diacrylate; triethylene glycol di(meth)acrylate; tripropylene glycol diacrylate; tetraethylene glycol diacrylate; neo-pentyl glycol diacrylate; propoxylated neopentyl glycol diacrylate; polyethylene glycol diacrylate; tetraethylene glycol diacrylate; bisphenol A epoxy diacrylate; 1,6-hexanediol dimethacrylate; tricyclodecane dimethanol diacrylate; trimethylol propane triacrylate; ethoxylated trimethylol propane triacrylate; propylated trimethylol propane triacrylate; tris(2-hydroxyethyl)-isocyanurate triacrylate; pentaerythritol triacrylate; phenylthioethyl acrylate; naphthyloxyethyl acrylate; MIRAMER M210 (available from Miwon Specialty Chemical Co., Ltd., Korea); KAYARAD R-604 (available from Nippon Kayaku Co., Ltd., Tokyo, Japan); epoxy acrylate under the product number RDX80094 (available from RadCure Corp., Fairfield, N.J.); and mixtures thereof. A variety of other curable materials can be included in the polymer layer, such as, e.g., vinyl ethers, vinyl naphthalene, acrylonitrile, and mixtures thereof. In some embodiments, the first acrylate layer comprises tricyclodecane dimethanol diacrylate.

Exemplary N-substituted (meth)acrylamides include (meth)acrylamides having one or two groups substituted on the nitrogen atom. Non-limiting examples of suitable N-substituted acrylamides include tertiary N-substituted acrylamides such as N,N-dimethylacrylamide, N,N-diethylacrylamide, N,N-dipropylacrylamide, N,N-dibutylacrylamide, N-ethyl-N-methylacrylamide, 4-acryloylmorpholine and the like, secondary N-substituted acrylamides such as N-(isobutoxy-methyl)acrylamide, N-(butoxymethyl)acrylamide, N-(allyloxymethyl)acrylamide, N-(isopropoxymethyl)acrylamide, N-propoxymethyl-acrylamide, N-ethoxymethyl-acrylamide, N-(methoxymethyl)acrylamide, N-propylacrylamide, N-butylacrylamide, N-decylacrylamide (N-[3-(N,N-dimethylamino)propyl]acrylamide), (N-[3-(N,N-diethylamino)propyl]acrylamide), (N-[3-(N-ethyl-N-methylamino)butyl]acrylamide), and the like. Non-limiting examples of suitable N-substituted cyclic acrylamides include 1-morpholin-4-yl-propenone, 1-piperidin-1-yl-propenone, 1-pyrrolidin-1-yl-propenone, and the like.

The first acrylate layer can be applied using standard coating methods. In some embodiments, the first acrylate layer coating is cured by UV radiation, electron beam, or plasma initiated free radical polymerization. In some preferred embodiments, the first acrylate layer is free of photo initiator and cured by electron beam.

The thickness of the first acrylate layer is sufficient to planarize the substrate (i.e., cover up any irregularities on the surface of the substrate due to, for example, surface debris or imperfections resulting from the manufacturing process). In some embodiments, the thickness of the first acrylate layer is at least 200 nm or at least 300 nm. In some embodiments, the thickness of the first acrylate layer is up to 1,000 nm, 900 nm, 800 nm, 700 nm, 600 nm, or up to 500 nm. In some embodiments, the thickness of the first acrylate layer ranges from 200 nm to 1,000 nm, from 300 nm to 1,000 nm, or from 350 nm to 500 nm.

### Release Layer

The release layer 130 comprises a metal layer or a doped semiconductor layer. The metal layer may include individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, and combinations thereof. In some embodiments, the metal layer may conveniently be formed of Al, AlOₓ, Zr, Cu, CuOₓ, Fe, NiCr, NiFe, SiAlOₓ, Ti, or Nb.

The release layer 130 may include a doped semiconductor layer. In some embodiments, the doped semiconductor layer may conveniently be formed of silicon, boron-doped silicon, aluminum-doped silicon, or phosphorus-doped silicon.

The release layer may comprise a single metal layer or doped semiconductor layer. Alternatively, the release layer may comprises two or more layers, each of which comprises a metal layer or doped semiconductor layer. For example, in the case of metal oxides having different deposition rates, it may be advantageous to fully cover the first acrylate layer with a higher deposition rate oxide, such as a shelf stable oxide (e.g., SiAlOₓ), followed by application of a lower deposition rate metal oxide, such as TiOx. Despite the low deposition rate, the TiOx layer provides an advantage in that it can absorb damaging UVC radiation while allowing curing wavelengths UVA/UVB to pass through to additional layers, thus mitigating degradation of one or more layers in the transfer article. Multiple layers can be used to tailor the properties of the release layer to the particular construction and/or application of the transfer article (e.g., the magnitude of the peel force).

The release layer can be prepared by evaporation, reactive evaporation, sputtering, reactive sputtering, chemical vapor deposition, plasma enhanced chemical vapor deposition, and atomic layer deposition. Preferred methods include vacuum preparations such as sputtering and evaporation. The release layer, as well as the first acrylate layer, are typically applied to the substrate in situ to reduce the potential for contamination during processing.

In preferred embodiments, the thickness of the release layer is as thin as possible to allow for transmission of UV curing radiation to additional layer (e.g., the second acrylate layer). In some embodiments, the thickness of the release layer is up to 50 nm, 40 nm, 30 nm, 20 nm, or up to 10 nm. In some embodiments, the thickness of the release layer is at least 1 nm, 2 nm, 3 nm, 4 nm, 5 nm, 6 nm, 7 nm, 8 nm, 9 nm, or at least 10 nm. In some embodiments, the thickness of the release layer is from 1 to 50 nm, from 1 to 40 nm, from 1 to 30 nm, from 1 to 20 nm, or from 1 to 10 nm.

Preferably, the substrate 110, first acrylate layer 120, and release layer 130 each transmit curing wavelengths of UV radiation. In some embodiments, normally incident radiation of at least one wavelength in the range of 250 nm to 400 nm has a percent transmittance through the substrate, first acrylate layer, and release layer of at least 1%, 10%, 20%, 30%, 40%, 50%, 60%, 70%, 80%, or at least 90%. In some embodiments, normally incident radiation of at least one wavelength in the range of 250 nm to 400 nm has a percent transmittance through the substrate, first acrylate layer, and release layer of at least 50%.

### Second Acrylate Laver

The second acrylate layer 140 can be selected from the same list of acrylates and acrylamides described with respect to the first acrylate layer 120. In some embodiments, the first acrylate layer 120 and second acrylate layer 140 are made from the same material. In other embodiments, the first acrylate layer 120 and second acrylate layer 140 are made from different materials.

The second acrylate layer can be applied using standard coating methods. In some embodiments, the second acrylate layer coating is cured by UV radiation, electron beam, or plasma initiated free radical polymerization. In some preferred embodiments, the second acrylate layer is free of photo initiator and cured by electron beam. In some embodiments, the first acrylate layer, second acrylate, or combination thereof is free of photo initiator.

In some embodiments, the thickness of the second acrylate layer is at least 50 nm, 100, run, 150 nm, 200 nm, or at least 300 nm. In some embodiments, the thickness of the second acrylate layer is up to 1,000 nm, 900 nm, 800 nm, 700 nm, 600 nm, or up to 500 mu. In some embodiments, the thickness of the second acrylate layer ranges from 100 nm to 1,000 nm, from 300 nm to 1,000 nm, or from 350 nm to 500 nm. In some applications, the second acrylate layer is etched away after transfer to the receiving material to reveal some or all of the function layer. Therefore, in some applications, it is preferable to keep the thickness of the second acrylate layer as small as practically possible for the intended application.

### Function Layer

In some embodiments, the function layer 150 can include a barrier layer, an optical layer, or an electrically conductive layer. In some embodiments, the function layer 130 can have a thickness of less than 10 μm, less than 5 μm, less than 4 μm, less than 3 μm or less than 2 μm.

The barrier layer may include at least one selected from the group consisting of individual metals, two or more metals as mixtures, inter-metallics or alloys, semi-metal or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof.

In some embodiments, the barrier layer may conveniently be formed of metal oxides, metal nitrides, metal oxy-nitrides, and metal alloys of oxides, nitrides and oxy-nitrides. In one aspect the barrier layer may include a metal oxide. In some embodiments, the barrier layer may include at least one selected from the group consisting of silicon oxides such as silica, aluminum oxides such as alumina, titanium oxides such as titania, indium oxides, tin oxides, indium tin oxide (ITO), hafnium oxide, tantalum oxide, zirconium oxide, zinc oxide, niobium oxide, and combinations thereof. Preferred metal oxides may include aluminum oxide, silicon oxide, silicon aluminum oxide, aluminum-silicon-nitride, and aluminum-silicon-oxy-nitride, CuO, TiO₂, ITO, ZnO, aluminum zinc oxide, ZrO₂, and yttria-stabilized zirconia. Preferred nitrides may include Si₃N₄ and TiN. The barrier layer can typically be prepared by reactive evaporation, reactive sputtering, chemical vapor deposition, plasma enhanced chemical vapor deposition, or atomic layer deposition. Preferred methods include vacuum preparations such as reactive sputtering and plasma enhanced chemical vapor deposition, or atomic layer deposition.

The barrier layer can be conveniently applied as a thin layer. The barrier layer material, e.g. silicon aluminum oxide, can for example, provide good barrier properties, as well as good interfacial adhesion to acrylate layers. Such barrier layers are conveniently applied by sputtering, and a thickness between about 5 and 100 nm is considered convenient, with approximately 27 nm in thickness being considered particularly suitable. In some embodiments, the barrier layer may have a water vapor transmission rate of less than 0.2, 0.1, 0.05, 0.01, 0.005 or less than 0.001 g/m²/day, thus providing good barrier properties.

The optical layer may include reflective, anti-reflective, partially absorbing, polarizing, retarding, diffractive, scattering, or transmissive properties over electromagnetic wavelengths of interest. Examples of optical layers may include diffusing or diffracting layers, where micro or nano-scale features with varying optical properties can scatter visible light. The optical layer may include a metal layer, e.g. Al, which is a broad-band reflector over the optical electromagnetic spectrum. The optical layer may include a high-low index pair materials, e.g. niobium pentoxide and silicon dioxide and can provide good reflectivity over optical wavelengths of interest by tuning their respective thicknesses. Other examples of optical layers include cavity enhanced absorbers which can create aesthetically pleasing colors over the visible spectrum of light as disclosed in U.S. Pat. No. 5,877,895 A (Shaw et al.). This optical layer can be created with two reflective or semi-transparent metal mirrors separated from each other by typically 50-750 nm.

The optical layer can be conveniently applied as a thin layer. Such layers are conveniently applied by sputtering, evaporation, or flash evaporation, and a thickness between 5 and 500 nm is considered convenient.

The electrically-conductive layer can include a conductive elemental metal, a conductive metal alloy, a conductive metal oxide, a conductive metal nitride, a conductive metal carbide, a conductive metal boride, a conductive polymer, graphene, and combinations thereof. Preferred conductive metals include elemental silver, copper, aluminum, gold, palladium, platinum, nickel, rhodium, ruthenium, aluminum, and zinc. Alloys of these metals, such as silver-gold, silver-palladium, silver-gold-palladium, or dispersions containing these metals in admixture with one another or with other metals also can be used. Transparent conductive oxides (TCO), such as indium-tin-oxide (ITO), indium-zinc-oxide (IZO), zinc oxide, with or without, dopants, such as aluminum, gallium and boron, other TCOs, and combinations thereof can also be used as an electrically-conductive layer. Preferably, the physical thickness of an electrically-conductive metallic layer is in a range from about 3 nm to about 50 nm (in some embodiments, about 5 nm to about 20 nm), whereas the physical thickness of the transparent conductive oxide layers are preferably in a range from about 10 nm to about 500 nm (in some embodiments, about 20 nm to about 300 nm). The resulting electrically-conductive layer can typically provide a sheet resistance of less than 300 ohms/square (in some embodiments, less than 200 ohms/square, or even less than 100 ohms/square). For function layers applied to a structured surface, the layer may follow the surface contour of the structured surface so that the electrical conductivity function is created at the interface between the structured surface and the deposited layer, and at the second surface of the functional coating layer contacting air or the surface of another substrate.

The electrically-conductive layer can be conveniently applied by sputtering, reactive sputtering, evaporation, reactive evaporation, and with a thickness between 5 and 500 nm. The electrically-conductive layer can be made, for example, from transparent conductive polymers. Conductive polymers include derivatives of polyacetylene, polyaniline, polypyrrole, PETOT/PSS (poly(3,4-ethylenedioxythiophene)/polystyrenesulfonic acid), or polythiophencs (see, e.g., Skotheim et al., Handbook of Conducting Polymers, 1998). Although not wanting to be bound by theory, it is believed that these polymers have conjugated double bonds which allow for conduction. Further, although not wanting to be bound by theory, it is believed that by manipulating the band structure, polythiophenes have been modified to achieve a HUMO-LUMO separation that is transparent to visible light. In a polymer, the band structure is determined by the molecular orbitals. The effective bandgap is the separation between the highest occupied molecular orbital (HOMO) and lowest unoccupied molecular orbital (LUMO).

The electrically-conductive layer can comprise, for example, anisotropic nano-scale materials which can be solid or hollow. Solid anisotropic nano-scale materials include nanofibers, nanowires, and nanoplatelets. Hollow anisotropic nano-scale materials include nanotubes. Typically, the nanotube has an aspect ratio (length:diameter) greater than 10:1 (in some embodiments, greater than 50:1, or even greater than 100:1). The nanotubes are typically greater than 500 nm (in some embodiments, greater than 1 micrometer, or even greater than 10 micrometers) in length. These anisotropic nano-scale materials can be made from any conductive material. Most typically, the conductive material is metallic. The metallic material can be an elemental metal (e.g., transition metals) or a metal compound (e.g., metal oxide). The metallic material can also be a metal alloy or a bimetallic material, which comprises two or more types of metal. Suitable metals include silver, gold, copper, nickel, gold-plated silver, platinum, and palladium. The conductive material can also be non-metallic (e.g., carbon or graphite (an allotrope of carbon)).

### Adhesive Layer

Adhesive layer 160 can include a viscoelastic or elastomeric adhesive. Viscoelastic or elastomeric adhesives can include those described in U.S. Patent Application Publication No. 2016/0016338 (Radcliffe et al.), for example, pressure-sensitive adhesives (PSAs), rubber-based adhesives (e.g., rubber, urethane) and silicone-based adhesives. Viscoelastic or elastomeric adhesives also include heat-activated adhesives which are non-tacky at room temperature but become temporarily tacky and are capable of bonding to a substrate at elevated temperatures. Heat activated adhesives are activated at an activation temperature and above this temperature have similar viscoelastic characteristics as PSAs. Viscoelastic or elastomeric adhesives may be substantially transparent and optically clear. Any of the viscoelastic or elastomeric adhesives of the present description may be viscoelastic optically clear adhesives. Elastomeric materials may have an elongation at break of greater than about 20 percent, or greater than about 50 percent, or greater than about 100 percent. Viscoelastic or elastomeric adhesive layers may be applied directly as a substantially 100 percent solids adhesive or may be formed by coating a solvent-borne adhesive and evaporating the solvent. Viscoelastic or elastomeric adhesives may be hot melt adhesives which may be melted, applied in the melted form and then cooled to form a viscoelastic or elastomeric adhesive layer. Suitable viscoelastic or elastomeric adhesives include elastomeric polyurethane or silicone adhesives and the viscoelastic optically clear adhesives CEF22, 817x, and 818x, all available from 3M Company, St. Paul, Minn. Other useful viscoelastic or elastomeric adhesives include PSAs based on styrene block copolymers, (meth)acrylic block copolymers, polyvinyl ethers, polyolefins, and poly(meth)acrylates. The adhesive layer can include a UV cured adhesive.

The transfer articles of the present disclosure utilize less release material by planarizing the substrate with the first acrylate layer. As noted above, this planarization leads to multiple benefits, including: cost reduction of the more expensive release materials; improved processing times for those release materials with lower deposition rates; and, optical transparency to UV curing radiation, allowing for curing through the release layer. In some embodiments, the transfer articles maintained acceptable peel performance for at least 1 year, at least 2 years, or at least 3 years, providing functional stability over long periods of time.

### EXAMPLES

The following examples are intended to illustrate exemplary embodiments within the scope of this disclosure. All percentages are by weight, unless otherwise noted. Reagents are from the Sigma-Aldrich Corporation (St. Louis, Mo.) unless otherwise noted. At the very least, and not as an attempt to limit the application of the doctrine of equivalents to the scope of the claims, each numerical parameter should at least be construed in light of the number of reported significant digits and by applying ordinary rounding techniques.

TABLE 1
Materials Used in the Examples

| Abbreviation | Description | Source |
|---|---|---|
| SR833 | tricyclodecane dimethanol | Sartomer Americas, Exton, PA, |
| | diacrylate, under trade designation | United States |
| | SARTOMER SR833S | |
| Al | >99% sputtering target | ACI Alloys of San Jose, Calif |
| SiAl | Si(90%)/Al(10%) rotary sputtering | Soleras Advanced Coatings US, |
| | target | Biddeford, ME, United States |
| TiOx | TiOx sputtering target, electrically | Protech Materials, Hayward, CA, |
| | conductive, 99.9% purity. | United States |
| Cu | >99% sputtering target | Soleras Advanced Coatings US |
| | | (Biddeford, ME)? |
| O₂ | Oxygen (UHP compressed gas) | Oxygen Service Company, St. Paul, |
| | | MN, United States |
| N₂ | Nitrogen (UHP compressed gas) | Oxygen Service Company, St. Paul, |
| | | MN, United States |
| Ar | Argon (UHP compressed gas) | Oxygen Service Company, St. Paul, |
| | | MN, United States |
| ST504 | Polyester film available under the | Du Pont Teijin Films, Chester, VA, |
| | trade designation MELINEX ST504 | United States |
| 3M ™ Polyester | 3M High Temp Polyester Powder | 3M Company, St. Paul, MN, United |
| Tape 8992 | Coating Masking Tape, 2” (about 5 | States |
| | cm) width | |
| Sulfuric Acid | >95% H₂SO₄ | Sigma-Aldrich Corporation, St. |
| | | Louis, MO, United States |

### Test Method 1: Peel Test

Peel force was measured using a T-Peel test according to ASTM D1876-08 “Standard Test Method for Peel Resistance of Adhesives (T-Peel Test)”. Samples measuring 2 inches by 6 inches (about 5 cm by 15 cm) were cut from sheets of coated film and laid coated side up on a smooth clean surface. A piece of Scotch® 3850 Shipping Packaging Tape was cut measuring about 8 inches (about 20.3 cm) long, aligned with the long edge of the sample, and applied to the coated side of the sample with a hard rubber hand roller using firm pressure. Care was taken to avoid the formation of creases or any entrapped air. A 1 inch (about 2.5 cm) wide test strip was slit out of the center of the laminated sample, in the long dimension, ensuring the two edge cuts were clean and parallel. The first one-quarter to one-half inch (about 0.63 cm to 1.3 cm) of the laminated test strip was separated and the two separated ends were secured in the grips of a tensile tester which was configured to conduct testing in a T-Peel geometry at a peel rate of 3 inches/minute (about 7.62 cm/minute) and record the peel force in grams. Within five minutes after the application of the tape to the sample, the peel was initiated and allowed to continue until at least 4 inches (about 10 cm) of the test strip length had been separated. The separated surfaces of the test strip were examined to determine location of failure, and the peel value was recorded in grams per linear inch. The instantaneous peel force was measured every 0.008 s and the average was taken over the duration of the peel length. The tests were done at about 74° F. and 72% relative humidity. A 2 kg load cell was used with a 4 second delay and a 0.13 cm/s peel rate. The peak peel force was the maximum instantaneous peel force experienced along the length of the strip.

### Test Method 2: 180° Peel Test Method

Test specimens were prepared as described in Test Method 1, except that the test strips were 2 inches (about 5 cm) wide and Tape 8992 was used. The test was conducted in a 180° peel geometry. The reported peel values were the average instantaneous peel forces over the length of the strip. The reported peak value was the maximum instantaneous peel force experienced along the length. A peel rate of 4 cm/s was used.

### Test Method 3: Water Vapor Transmission Rate

The water vapor transmission rate (WVTR) of test specimens was measured using commercially available water vapor transmission testing equipment (PERMATRAN W700 from Mocon, Inc. (Minneapolis, Minn.)) in accordance with ASTM F-1249. The testing regime was 50° C. and 100% relative humidity (RH).

### Test Method 4: Sulfuric Acid Test

10 ml of Sulfuric Acid was added to the last vacuum deposited layer and allowed to settle for 30 minutes and react with the underlying polyethylene terephthalate (PET). After rinsing the surface with water, white etch-pits on the PET were observed where the acid was in large enough concentration to disassociate PET into terephthalic acid and ethylene glycol. The number of pits was counted on a # per square inch (6.452 cm²) basis using a desktop scanner and ImageJ.

### Test Method 5: UV Transmission

Transmission was measured on a PerkinElmer Lambda 1050 spectrometer fitted with a 150 mm integrating sphere accessory at 61 wavelengths between 190-800 nm using standard PMT detector settings. A standard tungsten visible light source (PerkinElmer) was used for the visible region, and a deuterium light source (PerkinElmer) was used for the ultraviolet region below 320 nm.

### Comparative Example 1 (CE1): Barrier Coating on Cu for Release

A function layer of a barrier film of CE1 and the following Examples of barrier films were made on a roll to roll vacuum coater similar to the coater described in U.S. Patent Application No. 2010/0316852 (Condo, et al.) with the addition of a second evaporator and curing system located between the plasma pretreatment station and the first sputtering system, and using evaporators as described in U.S. Pat. No. 8,658,248 (Anderson et al.). This coater was outfitted with a substrate in the form of an indefinite length roll of 0.05 mm thick, 14 inch (35.6 cm) wide polyethylene terephthalate (PET) film manufactured by 3M Company. The substrate was prepared for coating by subjecting it to a nitrogen plasma treatment to improve the adhesion of the metallic layer on the unprimed side. The film was treated with a nitrogen plasma operating at 120 W using a titanium cathode, using a web speed of 8.0 meters/min and maintaining the backside of the film in contact with a coating drum chilled to 0° C.

On this prepared PET substrate, the release layer of Cu was deposited in-line with the previous plasma treatment step. The copper deposition used a conventional direct current (DC) sputtering process operated at 2 kW of power to deposit a 7 nm thick layer onto the substrate at a line speed of 26 fpm (8.0 m/min). The Cu coated PET substrate was then rewound.

In a second pass at a line speed of 16 fpm (4.9 m/min), an acrylate layer of SR833 was formed on the surface of the Cu layer. The acrylate layer was applied by ultrasonic atomization and flash evaporation to make a coating width of 12.5 inches (31.8 cm). The flow rate of this mixture into the atomizer was 0.67 ml/min to achieve a 375 nm layer, the gas flow rate was 60 standard cubic centimeters per minute (sccm), and the evaporator temperature was 260° C. Once condensed onto the Cu layer, this monomeric coating was cured immediately with an electron beam curing gun operating at 7.0 kV and 4.0 mA.

On this cured in-situ organic layer, an inorganic oxide barrier function layer of silicon aluminum oxide was applied in the same pass through the vacuum coater. This silicon aluminum oxide layer was laid down using an alternating current (AC) reactive sputter deposition process employing a 40 kHz AC power supply. The voltage for the cathode during sputtering was controlled by a feed-back control loop that monitored the voltage and controlled the oxygen flow such that the voltage would remain high as the outer surface of the target would not be fully oxidized or insulated preventing a crash of the target voltage. The system was operated at 16 kW of power to deposit a 25 nm thick layer of silicon aluminum oxide onto the cured organic layer.

A further in-line process was used to create a second polymeric layer on the surface of the silicon aluminum oxide layer, also in the same pass through the vacuum coater. This polymeric layer was produced by atomization and evaporation of a monomer mixture containing SARTOMER SR833S (94 weight percent (wt %)) and DYNASYLAN 1189 (6 wt %) (available from Evonik Industries (Essen, Germany). The flow rate of this mixture into the atomizer was 0.67 ml/min to achieve a 375 nm layer, the gas flow rate was 60 sccm, and the evaporator temperature was 260° C. Once condensed onto the inorganic layer, the coated acrylate monomer mixture was cured with an electron beam operating at 7 kV and 10 mA.

This completed CE1 film was tested within two weeks of manufacture using Test Method 1 described above. The average peel off force in units of g/in was measured to be 3.9, with a peak peel off force of 4.9.

### Comparative Example 2 (CE2): Barrier Coating on SiAl for Release

A barrier coating on metal construction was prepared as in CE1, except in place of the Cu layer deposition, SiAl was deposited at a line speed of 32 fpm (9.8 m/min).

The cathode had a Si(90%)/Al(10%) target obtained from Soleras Advanced Coatings US, of Biddeford, (Me.). A conventional AC sputtering process employing Ar gas and operated at 16 kW of power was used to deposit a 7 nm thick layer of SiAl alloy onto the substrate.

The completed CE2 film was tested within two weeks of manufacture using the T-peel measurement according to Test Method 1 described above. The peel off force in units of g/in was measured to be 2.0, with a peak peel off force of 3.0.

The water vapor transmission rate of the CE2 film was measured according to Test Method 3 discussed above. The water vapor transmission rate in this experiment was found to be less than 0.005 g/m²/day.

### Comparative Example 3 (CE3): Barrier Coating on Al for Release

A barrier coating on metal construction was prepared as in CE1, except in place of the Cu layer deposition, Al was deposited at a line speed of 9.5 fpm (2.9 m/min).

A cathode Al target obtained was used in a conventional DC sputtering process employing Ar gas and operated at 2 kW of power to deposit a 7 nm thick layer of Al onto the substrate.

The completed CE3 film was tested within two weeks of manufacture using the T-peel measurement according to Test Method 1 described above. The peel off force in units of g/in was measured to be 6.8 with a peak of 350 g/in.

### Comparative Example 4 (CE4): Barrier Coating on SiAlOx for Release

A barrier coating on oxide construction was prepared as in CE1, except in place of the Cu layer deposition, silicon aluminum oxide [SiAlOx] was deposited at a line speed of 7 fpm (2.1 m/min).

The SiAlOx was laid down by an AC reactive sputter deposition process employing a 40 kHz AC power supply. The voltage for the SiAl cathode during sputtering was controlled by a feed-back control loop that monitored the voltage and controlled the oxygen flow such that the voltage would remain high and not crash the target voltage. The system was operated at 16 kW of power to deposit a 20 nm thick layer of silicon aluminum oxide.

The completed CE4 film was tested within two weeks of manufacture using the T-peel measurement according to Test Method 1 described above. The peel off force in units of g/in was measured to be 8 g/in with a peak peel force of 400 g/in. Test method 5 showed 67% transmission at 325 nm.

### Example 1 (E): Barrier Coating on Planarized SiAl for Release

A barrier coating on SiAl was prepared as in CE2, except underneath the SiAl release layer, a 375 nm layer of SR833 was deposited similarly to the CE1 ‘first acrylate layer’.

### Example 2 (E2): Barrier Coating on Planarized Al for Release

A barrier coating on Al was prepared as in CE3, except underneath the Al release layer, a 375 nm layer of SR833 was deposited similarly to the CE1 ‘first acrylate layer’.

### Example 3 (E3): Barrier Coating on Planarized SiAlOx for Release

A barrier coating on SiAlOx was prepared as in CE4, except underneath the SiAlOx release layer, a 375 nm layer of SR833 was deposited similarly to the CE11 ‘first acrylate layer’.

### Ambient Aging

CE1-CE4 and E1-E3 were stored in ambient laboratory conditions for extended periods of time as shown in Table 2. Peel testing was completed throughout the aging of the examples to see if they maintained acceptable peel performance of the layers above the release layer, or if the material did not maintained performance by releasing the metal or doped semiconductor comprising release layers to the tape as well.

TABLE 2

| | Acrylate Between | | | | | |
|---|---|---|---|---|---|---|
| | Release Layer | Release | <2 Weeks | 3 Months | 3 Years | 5 Years |
| Example # | and PET | Layer | Aging | Aging | Aging | Aging |
| CE1 | No | Cu | Maintained | Maintained | Did not | n.a. |
| | | | Performance | Performance | maintain | |
| | | | | | performance, | |
| | | | | | Cu transferred | |
| | | | | | during Peel | |
| | | | | | testing | |
| CE2 | No | SiAl | Maintained | Maintained | Did not | n.a. |
| | | | Performance | Performance | maintain | |
| | | | | | performance, | |
| | | | | | SiAl transferred | |
| | | | | | during Peel | |
| | | | | | testing | |
| CE3 | No | Al | Maintained | Maintained | Did not | n.a. |
| | | | Performance | Performance | maintain | |
| | | | | | performance, | |
| | | | | | Al transferred | |
| | | | | | during Peel | |
| | | | | | testing | |
| CE4 | No | SiAlOx | Maintained | Maintained | Did not | n.a. |
| | | | Performance | Performance | maintain | |
| | | | | | performance, | |
| | | | | | SiAlOx | |
| | | | | | transferred | |
| | | | | | during Peel | |
| | | | | | testing | |
| E1 | Yes, 375 | SiAl | Maintained | Maintained | Maintained | Maintained |
| | nm | | Performance | Performance | Performance | Performance |
| E2 | Yes, 375 | Al | Maintained | Maintained | Maintained | Maintained |
| | nm | | Performance | Performance | Performance | Performance |
| E3 | Yes, 375 | SiAlOx | Maintained | Maintained | Maintained | Maintained |
| | nm | | Performance | Performance | Performance | Performance |

n.a. means not applicable.

### Example 4 (E4): Acrylate on Planarized SiAl for Release

A coating on planarized SiAl was prepared as in E1, except only the acrylate layer of the barrier stack was deposited. i.e. three material layers on the surface of PET:[PET|planarizing-SR833|SiAl|SR833]. Test Method 4 showed 10 pits.

### Examples 5-10 (E5-E10) and Comparative Examples 5-7 (CE5-CE7): Planarizing Release Layer

As in E4, various in-situ planarizing SR833 thicknesses were explored using a subset the methods described in the previous examples to determine a preferred range of thicknesses for the planarizing acrylate layer. Thicknesses were changed by adjusting line speed of the PET during deposition. The findings are summarized in Table 3.

TABLE 3

| | | Planarizing | Release | ~# of Pits ( Test |
|---|---|---|---|---|
| Example | Substrate | Thickness (nm) | Layer | Method 4) |
| Example 5 (E5) | Unprimed side of | 375 | SiAl | 10 |
| | CE1 PET | | | |
| Comparative | | 0 | SiAlOx | 500 |
| Example 5 (CE5) | | | | |
| Example 6 (E6) | ″″ | 187 | ″ | 100 |
| Example 7 (E7) | | 375 | ″ | 10 |
| Example 8 (E8) | | 750 | ″ | 10 |
| Example 9 (E9) | | 1250 | ″ | 100 |
| Comparative | Primed side of CE1 | 0 | ″ | 500 |
| Example 6 (CE6) | PET | | | |
| Comparative | Primed side of ST504 | 0 | ″ | 500 |
| Example 7 (CE7) | | | | |
| Example 10 (E10) | Unprimed side of | 375 | ″ | 10 |
| | ST504 | | | |

### Example 11 (E11): Acrylate on SiAlOx/TiOₓ for Release

An SR833 coating on planarized TiOₓ was prepared as in the previous examples, except underneath the TiOx a layer of SiAlOx was added due to the understood stability of the SiAlOx layer with the underlying planarizing acrylate. This silicon aluminum oxide layer was laid down using an alternating current (AC) reactive sputter deposition process employing a 40 kHz AC power supply. The voltage for the cathode during sputtering was controlled by a feed-back control loop that monitored the voltage and controlled the oxygen flow such that the voltage would remain high and not crash the target voltage. The system was operated at 16 kW of power to deposit a 6 nm thick layer of silicon aluminum oxide onto the planarizing organic layer.

The TiOx cathode was DC powered at 1.8 kW and the PET substrate line speed was 2 fpm and multiple passes under the cathode were utilized to deposit 25 nm in a controlled Ar/02 environment (325:6 ratio of Ar:O₂).

A further in-line process was used to create a transferrable polymeric layer on the surface of the TiOx layer, also in the same pass through the vacuum coater. This polymeric layer was produced by atomization and evaporation of a monomer containing SR833S. The flow rate of this mixture into the atomizer was 0.67 ml/min to achieve a 375 nm layer, the gas flow rate was 60 sccm, and the evaporator temperature was 260° C. Once condensed onto the inorganic layer, the coated acrylate monomer mixture was cured with an electron beam operating at 7 kV and 10 mA. Test method 4 showed a 48 g/in peel force. Test method 5 showed 24% transmission at 325 nm.

### Example 12 (EX12): Acrylate on SiAlOx/TiOₓ for Release

An SR833 coating on planarized TiOₓ was prepared as in E9, except the SiAlOx thickness was increased to 20 nm, and the TiOx thickness was decreased to 6 nm. Test method 5 showed 50% transmission at 325 nm. Test method 4 showed a 25 g/in peel force.

Thus, the present disclosure provides, among other things, a transfer article. Various features and advantages of the present disclosure are set forth in the following claims.

1. A transfer article comprising:
a substrate;
a first acrylate layer overlaying the substrate layer, the first acrylate layer having a thickness of at least 200 nm;
a release layer overlaying the first acrylate layer, the release layer comprising a metal layer or a doped semiconductor layer and having a thickness up to 50 nm;
a second acrylate layer overlaying the release layer; and
a function layer overlaying the second acrylate layer,
wherein the substrate is planarized by the first acrylate layer.

2. The transfer article of claim 1, wherein the substrate has a thickness of 1 mil (25.4 μm) to 5 mil (127 μm).

3. The transfer article of claim 1, wherein the substrate comprises polyethylene terephthalate (PET), polycarbonate, polypropylene (PP), or cyclic olefin copolymer (COC).

4. The transfer article of claim 1, where the substrate comprises polyethylene terephthalate.

5. The transfer article of claim 1, wherein the thickness of the first acrylate layer is 300 nm to 1,000 nm.

6. The transfer article of claim 1, wherein the thickness of the release layer is less than 10 nm.

7. The transfer article of claim 1, wherein the release layer comprises a metal layer.

8. The transfer article of claim 7, wherein the metal layer comprises Al, AlOₓ, Zr, Cu, CuOₓ, Fe, NiCr, NiFe, SiAlOₓ, Ti, or Nb.

9. The transfer article of claim 7, wherein the metal layer comprises TiO₂, and further including a layer of SiAlOx between the metal layer and the first acrylate layer.

10. (canceled)

11. The transfer article of claim 1, wherein the release layer comprises a doped semiconductor layer.

12. The transfer article of claim 11, wherein the doped semiconductor layer comprises silicon, boron-doped silicon, aluminum-doped silicon, or phosphorus-doped silicon.

13. The transfer article of claim 1, wherein the function layer comprises a barrier layer.

14. The transfer article of claim 1, wherein the function layer comprises an optical layer.

15. The transfer article of claim 1, wherein the function layer comprises an electrically conductive layer.

16. The transfer article of claim 1, wherein the release value between the release layer and the second acrylate layer is from 2 to 60 g/in.

17. The transfer article of claim 1, wherein a force required to separate the second acrylate layer from the release layer is less than each of a force required to separate the release layer from the first acrylate layer and a force required to separate the first acrylate layer from the substrate.

18. The transfer article of claim 1, wherein the first acrylate layer, second acrylate, or combination thereof is free of photo initiator.

19. The transfer article of claim 1, wherein normally incident radiation of at least one wavelength in the range of 250 nm to 400 nm has a percent transmittance through the substrate, first acrylate layer, and release layer of at least 50%.

20. A method comprising:
applying the transfer article of claim 1 to a surface of a receiving article, the function layer being between the release layer and the surface of the receiving article; and
removing the release layer from the second acrylate layer,
wherein the second acrylate layer and the function layer are left on the surface of the receiving article after removal of the release layer.

21. The transfer article of claim 14, wherein the optical layer includes anti-reflective properties.
